(19) United States
(12) Patent Application Publication
(10) Pub. No.: US 2008/0063213 A1
(43) Pub. Date: Mar. 13, 2008

(54) Audio player with decreasing environmental noise function

(76) Inventor: Junichi Kakumoto, Tokushima (JP)

Correspondence Address: BACON & THOMAS, PLLC, 625 SLATERS LANE, FOURTH FLOOR, ALEXANDRIA, VA, 22314, US

(21) Appl. No.: 11/889,805

(22) Filed: Aug. 16, 2007

(30) Foreign Application Priority Data
Sep. 8, 2006 (JP) JP2006-275797

(51) Int. Cl. G10K 11/16

(52) U.S. Cl. 381/71.6

(57) ABSTRACT

The present invention relates to an audio player for deceasing environment noise. The audio player includes an element arranged between a sound player and hearing to degrade playing sound and the environmental noise. An anti-decaying character is produced by electrical signal of the sound player to decrease the environmental noise corresponding to the decaying character of the decaying element and play an excellent timbre.

### FIELD OF THE INVENTION

The present invention relates to audio players, and more particularly to a practical and cheap audio player, which is manufactured and used easily, decreases energy consumption and has an excellent playing timbre. The present audio player has a mode for decreasing noise different from others, and has a wide range in applying. Furthermore, the present audio player can enjoy music in low noise, and be almost assembled in all of devices.

### DESCRIPTION OF THE RELATED ART

Generally, earphones or microphones sold in market, which are prone to enjoy music and broadcasting by decreasing environmental noise, can be divided into two kinds, active mode earphones or microphones and passive mode earphones or microphones.

The active mode earphones or microphones have excellent characters. The principle thereof is applying an opposite phase vibration of object spaces in some spaces for transmitting environmental noise to decrease the energy of the environmental noise of the object spaces, and reflecting conversely the environmental noise at opposite terminals. The active mode earphones or microphones are prone to eliminate the environmental noise in theory. However, the vibration will be unsteadily if the active mode earphones or microphones are applied in a bandwidth range above 500 Hz to enhance the characters thereof, therefore, a perfect eliminating device is different to be obtained.

The passive mode earphones or microphones have many limits, such as prerequisite consumed current of stability and portability of manufacturing technology, cost, and action. Furthermore, now the technologies covering the passive mode earphones or microphones cannot be solved. Therefore, the technology eliminating high bandwidth from 300˜500 Hz are relying on not the active mode but the noise effect produced by the passive mode. The cost of the mode goods is high, and users using the mode goods are little. However, the mode goods can enhance the satisfaction of the users.

A plurality of patent applications have relate to the active mode device for decreasing device. The following is examples.

A patent application of JP 2001-5463 discloses an audio device.

A patent application of JP H7-264699 discloses an audiphones.

A patent application of JP H9-36763 discloses a device for decreasing noise.

A patent application of JP 2006-139307 discloses a device having processing sound and controlling noise function.

A patent application of JP H5-30585 discloses an earphone device for decreasing noise.

A patent application of JP H5-130691 discloses an earphone.

A patent application of H8-47074 discloses a dialogic earphone.

A patent application of JP H8-79873 discloses a wireless fixed terminal.

A patent application of JP H8-275281 discloses an earphone for eliminating noise.

A patent application of JP H11-308685 discloses an earphone for decreasing noise actively.

A patent application of JP 2000-57876 discloses an audio device and an earphone.

A patent application of JP H6-6886 discloses an earphone for decreasing noise.

A patent application of JP H6-70391 discloses an earphone device.

A patent application of JP H7-240989 discloses an earphone device for decreasing noise.

Furthermore, a patent application of JP 2005-184578 (earhanging sound transmitter) discloses a technology for bone conduction.

Generally, the passive mode is a method for eliminating the environmental noise between the sources of the environmental noise and the microphones. A sound insulation portion must be used at the outside of the earphone to enhance the function of sound insulation, and therefore, it is not adapt to portability. A patent application of JP H08-275298 (device for assembling earphone and earphone) and a patent application of JP H10-511832 (head cover having ear pad and controllable pad compressing device) use sound insulation material into interspaces between the ear and the earphone. They can improve the function, but since the environmental noise is transmitted into the ear through a vibrating board of the earphone, they cannot satisfy the need for decreasing noise.

In addition, a patent application of JP 2002-200109 (earplug electric audio conversion device) transmits vibrating of a vibrating board of an earphone to a sound insulation element of an earplug for decreasing noise. However, since the sound insulation element is an elastomer, and even if the element is vibrated directly, it cannot obtain a perfect audio effect.

### BRIEF SUMMARY

The present invention uses a decaying element between microphones and ears to decay wanted environmental noise and music or broadcasting.

An audio player in accordance with a preferred embodiment of the present invention, includes a decaying element mounted between an ear terminal of an earphone and hearing to degrade sound, a decaying character P(f), an anti-decaying character p(f), and a sound character. The a decaying character P(f) is a sound character in human hearing range transmitted electrically from decaying element to the earphone and the hearing. The anti-decaying character p(f) is an opposite character to the decaying character P(f). The sound character is equal to the anti-decaying character p(f) or similar to the decaying character P(f), and drives the decaying element of the electrical circuit of the earphone. The audio player degrades environmental noise and makes the playing timbre same to timbre having no decaying element and anti-decaying element.

By using such this condition and electrical signals in stage, the inversed transmitting characters of the decay characters from the microphones to the ears produce effect to modify playing signals for driving the microphones.

Therefore, the present invention can not only decrease the environmental noise but also modify the decaying playing timbre to produce normal timbre and provide a ratio of S/N.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an first embodiment of the present invention;

FIG. 2 is a schematic view of an first embodiment of the present invention;

FIG. 3 is a character chart of a decaying character of a decaying element;

FIG. 4 is a character chart of an anti-decaying character;

FIG. 5 is a character chart for enhancing timbre having no relation to the anti-decaying character;

FIG. 6 is a character chart of combining the anti-decaying character and the character for enhancing timbre;

FIG. 7 is a peak value maintain histogram of spectrum density of music signals;

FIG. 8 is a chart showing the anti-decaying character produced by the music signal of FIG. 7 and the decaying character of FIG. 3;

FIG. 9 is a chart showing frequency distribution of the music signal of FIG. 7 and the anti-decaying character of FIG. 4; and

FIG. 10 is a chart showing frequency distribution of the music signal of FIG. 7, the anti-decaying character of FIG. 4 and the character for enhancing timbre of FIG. 5.

### DETAILED DESCRIPTION

Reference will now be made to the drawings to describe a preferred embodiment of the present audio player, in detail.

First at all, the present audio player can be applied in an earphone having a decaying element mounted thereon, an earphone having a decaying element which can be mounted/demounted, a decaying element which can be used in an earphone, a mobile phone device having an anti-decaying character, a portable computer having an anti-decaying character, a playing fixing terminal device of an aircraft cabin having an anti-decaying character, a playing fixing terminal device of a tram seat having an anti-decaying character, and a TV receiver having an anti-decaying character.

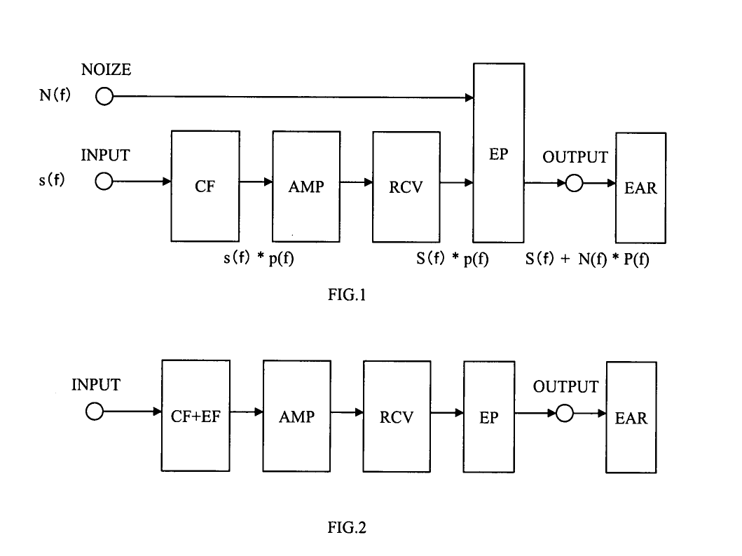

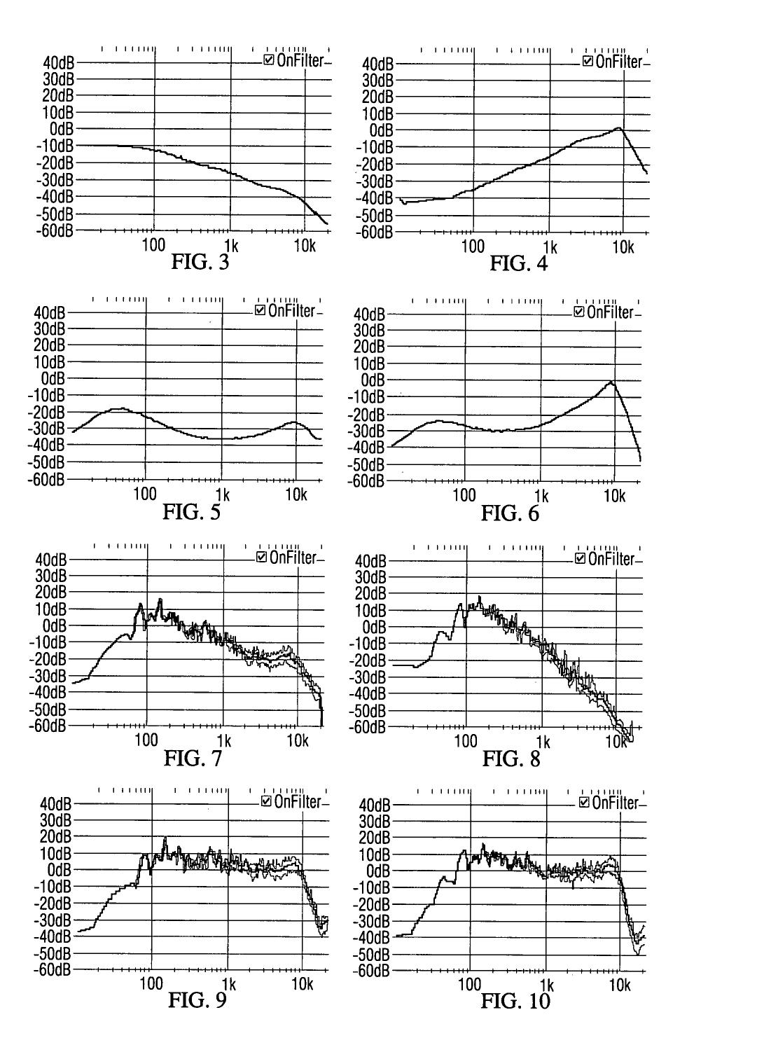

FIG. 1 is a block diagram of an embodiment of the present invention. The following will introduce the present invention by FIG. 1 cooperating with claims 1 and 2.

Firstly, INPUT is used as a signal input terminal of playing, NOSE is environmental sound, N(f) is environmental noise, s(f) is an input signal of playing, CF is an anti-decaying filter having an anti-decaying character, p(f) is an anti-decaying character, and the anti-decaying filter has an output of s(f)*p(f). In addition, AMP is used to drive a power amplifier of a microphone, RCV is a handset, and the handset RCV has an output of S(f)*p(f). S(f) is used to make the input signal s(f) play the handset RCV. EP is a decaying element, an input of the decaying element EP is a sum of the output S(f)*p(f) of the handset RCV and the environmental noise N(f), that is S(f)*p(f)+N(f). To explain briefly, assuming the character of the playing signal of the decaying element EP is equal to that of the environmental noise, the output of the decaying element EP is an input of the ear, which is S(f)*p(f)*P(f)+N(f)*P(f). Since p(f)*P(f) is equal to 1, the sound transmitted to the ear will be S(f)+N(f)*P(f), that is, the playing signal will be original timbre and the environmental noise will be degraded gradually by the decaying element EP.

In theory, the present invention need remove substantially the dynamic range of the power amplifier and the handset. For example, if the maximal decaying amount of the decaying character is 30 db and should be modify completely, the maximal gain of the anti-decaying character will be 30 db. That is one only shortcoming of the present invention. However, the current goods sold in market, have the dynamic range even if they are used in a very noisy environment. Therefore, the conventional dynamic range of the amplifier or the earphone should be removed more substantially to make the present invention having the dynamic range.

FIG. 2 is a block diagram of an equalizer having a function of adjusting general timbre having the anti-decaying character as described in claim 4 or a condition of improving timbre of an embodiment of the present invention. FIG. 2 is similar to FIG. 1, except that the process of processing the signal having the anti-decaying character and the timbre adjustment. Generally, if the filter is a linear filter, the source of the filter will be limited in a minimal range. The other functions of FIG. 2 is same to those of FIG. 1, therefore, the other functions of FIG. 2 are explained elliptically.

FIGS. 3 to 10 are results from actual audio playing experiments of embodiments of the present invention. X axis of each figure shows frequency, and Y axis thereof shows grain or spectrum density. Absolute grain of Y axis has no any great significance. The relative differences of the grain between each frequency of the figures have great significance. The absolute grain is controlled by the operated volume of the goods, therefore it is have no need to be explained and is omitted.

FIG. 3 is an example of the decaying character of the decaying element. The character is not measuring directly the decaying character from the decaying element to the ear, but selecting randomly frequency points to measure signal levels feeling same volumes, and the character of the filter is simulated and measured by the filter character approximately drawn in the figure.

FIG. 4 is showing the anti-decaying character of the decaying character of FIG. 3.

FIG. 5 is an example of improving generally timbre.

FIG. 6 is showing a character by sum the anti-decaying character of FIG. 4 and the improving timbre character of FIG. 5. Generally, any current player at least has strengthened bass. Therefore, the present invention will combine the two characters.

FIG. 7 is showing a peak value maintain histogram of spectrum density of music signals. The natural music all has a right-side rough tendencies of 1/f.

FIG. 8 is a histogram of the music of FIG. 7 producing the decaying character of FIG. 3. Generally, the music having similar spectrum distribution, fail almost to be felt higher frequency, and have similar timbre to generally playing music timbre heard from the earphone of the earplug used in the aircraft cabin. The decaying elements may be changed relaying on the material or construction or the shape of the ear, but they generally have the right tilting character.

FIG. 8 is used to show that the histogram of FIG. 9 will produce the anti-decaying character of FIG. 4. Although the grain of alt are increased substantially, the music heard has a distribution of spectrum density of approximate 1/f, and does not need to change the dynamic range of the electronic circuit. Generally, the normal music or broadcasting may also produce the anti-decaying character over the limitation and have enough dynamic range, therefore, they have no problems in fact. If artificial sine wave signal or white noise signal (white noise) are used to measure, the dynamic range will not enough.

FIG. 10 is a histogram showing the anti-decaying character and the improving timbre character of the FIG. 6.

Since the correctly measuring the decaying character of the hearing (ear) of the decaying element is difficult, the actual method is using the actual hearing to determinate the anti-decaying character. From FIGS. 3 to 10, the characters of the examples are simulated by relying on the hearing in approximate 30 minutes. Therefore, they are excellent in functions of decreasing and playing timbre.

In some embodiments, if the audio player is in the environment noise, the decaying element is used, and if not, the decaying element needs not to be used. Therefore, the audio player as goods must have a selecting function of these modes. In addition, the audio player must have a function of selecting anti-decaying character by using the decaying character of the decaying element.

If the functions of the decaying elements may be improved, the dynamic range of the anti-decaying character will be increased and the redundant dynamic range of the amplifier or handset will be increased. Generally, a synthesizer can be used to perform music, and can be used to perform any amplitude distributing music. IF the playing device is over the dynamic range to produce saturation distortion or mixed tunes distortion, the price of playing device will be decreased. Therefore, the distortion is not being wanted to produce at any position. The signal processing portion of the amplifier and microphone has the compression function, which can produce significant effect. In addition, improving the cost efficiency of the device in theory is to avoid overspecification, therefore, the compression function is added into the electrical circuit. The compression function is not the essence of the invention.

The decaying element of the present invention has the excellent characters in the alt, and there is a little shortcoming in the bass compressed with the alt. The bass function is not prone to be controllable compared with the alt function. Of course, it is inevitable to make up the shortcomings of the two functions and further decrease the noise. The present invention can be combined to solve many problems, such as problem of hardly raising active locating closed-loop grain.

The earphone is a consumable. Since the each user has a different using condition or design hobby, the earphone having the decaying element must be manufactured to be sold.

Since the decaying element may touch the body, they may be polluted and must be replaced.

From the above, the present invention is performing a function for decreasing noise, which is simple, and has high functions, lower cost and high stability.

The anti-decaying character can be added into the music comprising and playing device, or the earphone of the mobile phone or the device using the headphone to hear the sound or the music through the current audio playing function. The anti-decaying character is removed in the no noise condition, and the anti-decaying character is produced in the noise condition through using the earphone having the decaying element or the decaying element. In addition, the function of decreasing noise can be further performed by mounting into the conventional products having active filter.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An audio player, comprising:
a decaying element mounted between an ear terminal of an earphone and hearing to degrade sound;
a decaying character P(f), being a sound character in human hearing range transmitted electrically from decaying element to the earphone and the hearing;
an anti-decaying character p(f) , being an opposite character to the decaying character P(f); and
a sound character, equal to the anti-decaying character p(f) or similar to the decaying character P(f), and driving the decaying element of the electrical circuit of the earphone,
wherein the audio player degrades environmental noise and makes the playing timbre same to timbre having no decaying element and anti-decaying element.

2. The audio player as claimed in claim 1, further comprising a switching function for selecting a function having the decaying character or a function having no the decaying function.

3. The audio player as claimed in claim 1, further comprising an equalizer or a fixing device for enhancing timbre to combine the anti-decaying character into a general sound device.

4. The audio player as claimed in claim 1, further comprising a function of changing the anti-decaying character p(f) or a function of selecting one from a plurality kinds.

5. The audio player as claimed in claim 1, further comprising an active noise eliminating device.

6. An audio player, comprising:
a decaying element mounted between an earphone terminal or an headphone terminal near to ears and hearing (ear) to degrade sound;
a decaying character P(f), being a sound character in human hearing range transmitted electrically from decaying element to the earphone and the hearing;
an anti-decaying character p(f), being an opposite character to the decaying character P(f); and
a sound character, equal to the anti-decaying character p(f) or similar to the decaying character P(f), and driving the decaying element of the electrical circuit of the earphone,
wherein the audio player degrades environmental noise and makes the playing timbre same to timbre having no decaying element and anti-decaying element.

7. The audio player as claimed in claim 6, further comprising a switching function for selecting a function having the decaying character or a function having no the decaying function.

8. The audio player as claimed in claim 7, further comprising an equalizer or a fixing device for enhancing timbre to combine the anti-decaying character into a general sound device.

9. The audio player as claimed in claim 8, further comprising a function of changing the anti-decaying character p(f) or a function of selecting one from a plurality kinds.

10. The audio player as claimed in claim 9, further comprising an active noise eliminating device.

11. A decaying element, which is the decaying element as claimed in claim 1, and is capable of being assembled to or being uninstalled from a main body of the earphone.
